(19) United States
(12) Patent Application Publication
(10) Pub. No.: US 2008/0257449 A1
(43) Pub. Date: Oct. 23, 2008

(54) DRY ADDITIVE METERING INTO PORTABLE BLENDER TUB

(75) Inventors: Jeremy Weinstein, Duncan, OK (US); Wesley J. Warren, Duncan, OK (US)

Correspondence Address: JOHN W. WUSTENBERG, P.O. BOX 1431, DUNCAN, OK, 73536, US

(73) Assignee: Halliburton Energy Services, Inc., Houston, TX (US)

(21) Appl. No.: 11/736,444

(22) Filed: Apr. 17, 2007

(51) Int. Cl. B65G 65/46

(52) U.S. Cl. 141/67; 141/231; 366/133; 507/200

(57) ABSTRACT

Oil wells may be fracture treated on-site in order to stimulate production. Such fracture treatment may be performed using a portable blender tub to mix fracturing fluid, proppant, and dry chemical additive into an injection slurry. A mechanical conveyance device may be adjustably attached to the portable blender tub, so that in its first position it is stowed for transport, while in its second position it is deployed for operation. When deployed, the mechanical conveyance device may mechanically convey and meter dry chemical additive into the blender tub, allowing a handler to feed and meter dry chemical additive while standing on the ground. This allows for improved safety and efficiency in fracture treating a wellbore.

### CROSS-REFERENCE TO RELATED APPLICATIONS

Not applicable

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

Embodiments relate generally to the field of oil well stimulation, drilling, and recovery, and more specifically to the on-site mixing of a proppant slurry with dry chemical additives for use in oil well fracturing.

### BACKGROUND

One common way to increase the production of a well, such as an oil or gas well, is to fracture the producing zone of the geological formation to allow the formation fluids to flow more freely through the formation into the well. The producing zones of geological formations are usually fractured by pumping fluids into the formation under high pressures. However, merely pumping a fluid into the formation during the fracturing operation would be insufficient for effective well stimulation, since upon cessation of the pumping of the fracturing fluid, the naturally occurring geological formation pressures would cause the fractured areas of the formation to close, once again restricting the flow of the formation fluids.

To prevent the geological formation from closing after fracturing pressure is removed, the fractures must be physically propped open. Thus, fracturing fluids utilized for such fracturing treatments often contain solid materials, generally referred to as proppants. The most commonly used proppant is sand, although a number of other materials (such as walnut shells, glass beads, sintered metals, etc.) can be used. The proppant is mixed with the fracturing fluid to form a slurry which is pumped into the well under pressure. When the fractures are formed in the formation, the slurry moves into the fractures. Subsequently, upon releasing the fracturing pressure, the proppant material remains in the fracture to prop the fracture open.

A blender truck is often used during operations in the field to accurately mix the proppants and other additive materials with the fracturing fluid in order to form the injection slurry for fracture treating a wellbore. Conventionally, dry chemical additives are transported in sacks to the well site location. The sacks are then manually carried up to a blender tub located on the blender truck and manually metered into the open top of the blender tub. The blender tub then mixes the dry chemical additives in with fracturing fluid and proppant in order to form the injection slurry for fracture treating the wellbore.

Commonly, dry chemical additive is introduced to the blender tub by being dropped into the top of the tub. This routinely involves a handler climbing on the top of the blender tub (typically located atop the back of a truck, trailer, or skid) which generally may be up to 13.5 feet high, in order to meter the dry chemical additives into the blender tub. Such climbing inherently creates a safety risk for handlers, with the danger of falling especially great in inclement weather. Unfortunately, safety harnesses are often not practically feasible as handlers climb atop blender tubs. Attachment points on ladders and the tops of tubs (of the sort that would be necessary to enable a safety harness to be latched) are easily damaged during loading/unloading and/or transport of the blender tubs. Thus, there may not be a convenient attachment point for latching, negating the practicality of using a safety harness. Even if there is an attachment point suitable for latching, the safety harness may not effectively protect handlers as they climb up atop the blender tub; it would be difficult for a handler to latch and unlatch a safety harness during a climb while carrying a sack of dry chemical additive. Furthermore, safety harnesses tend to restrain movement, which could further complicate the process of feeding the blender tub (especially as the handlers climb up and down with heavy sacks).

Consequently, it is not uncommon for the handler metering the dry chemical additives to climb unsecured to the top of a tub to introduce the bagged dry chemical additive by emptying the bags into a metering auger via a hopper located above the top of the blender tub. This unsafe practice becomes even more dangerous when weather conditions, such as snow, wind, and rain, exacerbate the difficulty of reaching the top of the blender tub. And in addition to these safety concerns, the current feeding process tends to be inefficient, since the dry chemical additive must be hauled up to the top of the blender tub by hand, one sack at a time. Accordingly, there is an ongoing need for an apparatus and a method for metering dry chemical additive into a blender tub that minimizes the risk of injury or death of a handler from falling while metering dry chemical additive into a blender tub, while increasing the efficiency of the feeding process for the blender tub.

### SUMMARY

In one aspect, the present disclosure is directed to a method for servicing a wellbore comprising transporting a portable proppant slurry blender tub to a well site to be serviced; deploying a mechanical conveyance device from a first position for storage during transport to a second position for feeding dry chemical additive for metered discharge into the blender tub; mechanically conveying dry chemical additive from at or near ground level to the top of the blender tub; and mechanically metering the dry chemical additive for discharge into the blender tub. In an embodiment, the method further comprises feeding the dry chemical additive into the mechanical conveyance device; wherein the dry chemical additive is fed into the mechanical conveyance device from sacks so that it may be mechanically conveyed in loose form from at or near ground level to the top of the blender tub. The dry chemical additive is generally a non-proppant material.

In another embodiment, the mechanical conveyance device further comprises an inlet and a discharge outlet; and in the second position the mechanical conveyance device has its inlet located at or near the ground and its discharge outlet located at or above the top of the blender tub so that the mechanical conveyance device discharges directly into the blender tub. The mechanical conveyance device may be deployed by pivoting and rotating the inlet of the mechanical conveyance device with respect to the blender tub. In still another embodiment, the blender tub is located on a vehicular conveyance apparatus having a longitudinal axis defining the length of the vehicular conveyance apparatus and a lateral periphery defining the width of the vehicular conveyance apparatus; and in the second position, the inlet of the mechanical conveyance device extends beyond the periphery of the vehicular conveyance apparatus. Deploying the mechanical conveyance device into the second position may further comprise pivoting the inlet of the mechanical conveyance device vertically upward with respect to the blender tub; rotating the inlet of the mechanical conveyance device through a lateral arc with respect to the bender tub and the longitudinal axis of the vehicular conveyance apparatus; pivoting the inlet of the mechanical conveyance device downward with respect to the blender tub; or combinations thereof.

In another embodiment, the method may further comprise adding fracturing fluid and proppant into the blender tub; blending the dry chemical additive with the fracturing fluid and the proppant within the blender tub to form an injection slurry; and fracture treating the wellbore with the injection slurry. The proppant and the dry chemical additive may be added to the blender tub simultaneously; and the amount of the dry chemical additive and the proppant added into the blender tub may be continuously controlled to maintain the injection slurry blend. In still another embodiment, the method may further comprise cutting open a sack of dry chemical additive, wherein the dry chemical additive is fed into the mechanical conveyance device by being poured from the open sack into the inlet. In yet another embodiment, the method may further comprise charging the mechanical conveyance device with dry chemical additive; discharging the mechanical conveyance device to remove dry chemical additive charged to the mechanical conveyance device; stowing the mechanical conveyance device from the second position to the first position in preparation for transportation; and transporting the portable blender tub from the well site upon completion of wellbore servicing.

In another aspect, the present disclosure is directed to a method for servicing a wellbore comprising transporting a portable proppant slurry blender tub to a well site to be serviced; mechanically conveying dry chemical additive from at or near ground level to the top of the blender tub; adding fracturing fluid to the blender tub; metering the dry chemical additive into the blender tub, e.g., at a first rate by a first conveyance device, and metering proppant into the blender tub, e.g., at a second rate by a second conveyance device, wherein the proppant and dry chemical additive are simultaneously metered into the fracturing fluid within the blender tub. The proppant, dry chemical additive, and fracturing fluid may be continuously added to the blender tub to form an injection slurry, even as the injection slurry is injected into the wellbore; and the amount of the dry chemical additive and the proppant added to the fracturing fluid in the blender tub is controlled to continuously maintain the injection slurry blend. Metering of the dry chemical additive may occur at a rate approximately in a range from 0.25 cubic feet per minute to 4 cubic feet per minute; with a volumetric accuracy of approximately 3% or better. In an embodiment, the method may further comprise deploying a mechanical conveyance device from a first storage position into a second feeding position.

In still another aspect, the present disclosure is directed to a device for servicing a wellbore comprising a mechanical conveyance device adjustably mounted to a portable proppant slurry blender tub; wherein the mechanical conveyance device has a first position for storage during transport and a second position for feeding dry chemical additive for discharge into the blender tub; and wherein in its second position, the mechanical conveyance device is operable to mechanically convey dry additive from at or near ground level to the top of the blender tub for metered discharge into the blender tub.

The mechanical conveyance device may be pivotally and rotatably mounted to the blender tub so as to be operable to be stowed securely in the first position for transport and deployed for feeding in the second position. The mechanical conveyance device may further comprise an inlet and a discharge outlet; and in the second position the mechanical conveyance device has its inlet located at or near the ground and its discharge outlet located at or above the top of the blender tub so that the mechanical conveyance device discharges directly into the blender tub. The blender tub may be located on a vehicular conveyance apparatus having a lateral periphery defining the width of the vehicular conveyance apparatus; and in the second position, the inlet of the mechanical conveyance device extends beyond the lateral periphery of the vehicular conveyance apparatus.

In an embodiment, the device may further comprise one or more sand screws for conveying proppant material into the blender tub. The mechanical conveyance device may further comprises a cleanout valve and a motor operable to drive the mechanical conveyance device in a forward direction for conveying dry additive to the blender tub and a reverse direction to discharge dry additive charging the mechanical conveyance device through the cleanout valve. The mechanical conveyance device may have a volumetric accuracy of 3% or better.

In another aspect, the present disclosure is directed to a method for servicing a wellbore comprising transporting a portable proppant slurry blender tub to a well site to be serviced; mechanically conveying dry chemical additive from at or near ground level to the top of the blender tub; and mechanically metering the dry chemical additive into the blender tub. In an embodiment, the method further comprises feeding the dry chemical additive into a mechanical conveyance device; wherein the dry chemical additive is fed into the mechanical conveyance device from sacks so that it may be mechanically conveyed in loose form from at or near ground level to the top of the blender tub. In another embodiment, the method further comprises deploying the mechanical conveyance device from a first position for storage during transport to a second position for feeding dry chemical additive for metered discharge into the blender tub. The dry chemical additive generally would be a non-proppant material. The rate of discharge into the blender tub would typically be approximately in a range from 0.25 cubic feet per minute to four cubic feet per minute, for dry chemical additive with a density approximately in a range from 30 to 70 lbm per cubic foot. Additionally, the mechanical conveyance device would typically have a discharge rate with a volumetric accuracy of approximately 3% or better.

In still another embodiment the mechanical conveyance device may comprise one of a group consisting of a metering screw, a pneumatic conveyor, a bucket conveyor, and a belt conveyor. In yet another embodiment, the mechanical conveyance device may further comprise an inlet and a discharge outlet; and in the second position the mechanical conveyance device may have its inlet located at or near the ground and its discharge outlet located at or above the top of the blender tub so that the mechanical conveyance device discharges directly into the blender tub. Additionally, for a blender tub located on a vehicular conveyance apparatus having a bumper, the mechanical conveyance device in the first position may have its inlet located on or above the bumper, while its discharge outlet is not positioned to discharge into the blender tub. Another embodiment may further comprise conditioning the dry chemical additive so that it is in loose form without clumps. The dry chemical additive may directly discharge into the blender tub. In yet another embodiment, the method may further comprise adding fracturing fluid and proppant into the blender tub; and blending the dry chemical additive with the fracturing fluid and the proppant within the blender tub to form an injection slurry for fracture treating the wellbore.

In still another embodiment, the method may further comprise controlling the rate at which the dry chemical additive is discharged into the blender tub to continuously maintain the appropriate injection slurry blend (as dry chemical additive, fracturing fluid, and proppant are all added continuously into the blender tub, and injection slurry is continuously pumped from the blender tub). In another embodiment, the method may further comprise fracture treating the wellbore. In an embodiment, the method may also comprise cleaning or discharging the mechanical conveyance device to remove the dry chemical additive charging the mechanical conveyance device. Finally, an embodiment of the method may further comprise stowing the mechanical conveyance device from the second position to the first position in preparation for transportation; and transporting the portable blender tub from the well site upon completion of wellbore servicing.

In another aspect, the present disclosure is directed to a method for servicing a wellbore comprising transporting a portable proppant slurry blender tub to a well site to be serviced; deploying a mechanical conveyance device from a first position for storage during transport to a second position for feeding dry chemical additive for discharge into the tub; feeding dry chemical additive from a sack into the mechanical conveyance device; mechanically conveying dry chemical additive in loose form from at or near ground level to the top of the blender tub; and metering the dry chemical additive for discharge into the blender tub. In one embodiment, the method may further comprise unlocking the mechanical conveyance device from its secured first position; extending a support bracket operable to hold the mechanical conveyance device in its second position; and locking the mechanical conveyance device in its second position on the support bracket. In another embodiment, the method may further comprise discharging metered dry chemical additive directly into the blender tub; wherein the mechanical conveyance device is operable to convey dry chemical additive with a density approximately in a range from 30 to 70 lbm per cubic foot; and the rate of discharge into the blender tub is approximately in a range from 0.25 cubic feet per minute to four cubic feet per minute. In still another embodiment, the method further comprises charging the mechanical conveyance device with dry chemical additive (in preparation for metering into the blender tub).

The mechanical conveyance device may have an inlet operable for feeding of the dry chemical additive into the mechanical conveyance device, and a discharge outlet operable to discharge dry chemical additive from the mechanical conveyance device; wherein in the second position the inlet is located in proximity to the ground and the discharge outlet is located in proximity to the top of the blender tub to directly discharge into the blender tub. In another embodiment, the method may further comprise conditioning the dry chemical additive to reduce clumps that might affect conveyance. In still another embodiment, the method may further comprise affixing a removable hopper to the inlet of the mechanical conveyance device. In yet another embodiment, the method may further comprise cutting open a sack of dry chemical additive, wherein the dry chemical additive is fed into the mechanical conveyance device by being poured from the open sack into the hopper.

The dry chemical additive is a non-proppant material in one embodiment. In another embodiment, wherein the hopper comprises a height-adjustable table, the method further comprises positioning a truck bed with sacks of additive in proximity to the hopper; adjusting the table height to approximately match the height of the truck bed; and sliding bags from the truck bed to the hopper along the table. In yet another embodiment, wherein the mechanical conveyance device further comprises a motor, the method may further comprise operating the motor to drive the mechanical conveyance device to convey the dry additive from the inlet to the discharge outlet. In an embodiment, the method may further comprise blending the dry chemical additive with fracturing fluid and proppant within the blender tub to form an injection slurry for fracture treating the wellbore. And in still another embodiment, the method may further comprise controlling the rate of discharge of the metered dry chemical additive into the blender tub to continuously maintain the injection slurry blend.

In another embodiment, the method may further comprise pumping the injection slurry into the wellbore. In still another embodiment, the method may further comprise reversing the motor to clean out the dry chemical additive charging the mechanical conveyance device. In yet another embodiment, the method may further comprise stowing the mechanical conveyance device from the second position to the first position in preparation for transportation; and transporting the portable blender tub from the well site upon completion of wellbore servicing. And another embodiment may further comprise unlocking the mechanical conveyance device from its second position affixed to the bracket; retracting the bracket; and locking the mechanical conveyance device into its first position in preparation for transport. The mechanical conveyance device may comprise a metering screw.

In yet another aspect, the present disclosure is directed to a device for servicing a wellbore comprising a mechanical conveyance device pivotally and rotatably mounted to a portable proppant slurry blender tub; wherein the mechanical conveyance device has a first position for storage during transport and a second position for feeding dry chemical additive for discharge into the blender tub; and wherein in its second position, the mechanical conveyance device is operable to mechanically convey dry additive from at or near ground level to the top of the blender tub for metered discharge into the blender tub. The mechanical conveyance device may comprise one from a group consisting of a metering screw, a pneumatic conveyor, a bucket conveyor, and a belt conveyor. The metering screw may further comprise an auger, a housing, and a motor; wherein the housing comprises an inlet and a discharge outlet, the auger is located within the housing, and the motor operates the auger.

In an embodiment, the device may further comprise a hopper for feeding dry additive into the mechanical conveyance device. The hopper may removably attach to the mechanical conveyance device. In another embodiment, the hopper may further comprise a sack cutter and a height adjustable table. In yet another embodiment, the device may further comprise a computer operable to continuously control discharge of the dry additive into the blender tub to maintain the slurry blend. In still another embodiment, the device may further comprise a pneumatic support operable to assist in manual positioning of the mechanical conveyance device. The mechanical conveyance device may also comprise an inlet end, a discharge outlet end, and a counterweight; wherein the counterweight is located in proximity to the discharge outlet end. The portable blender may be located on either a trailer or a skid. In another embodiment, the device further comprises a cleanout valve and a motor operable to drive the mechanical conveyance device in a forward direction for conveying dry additive to the blender tub and a reverse direction to eject dry additive charging the mechanical conveyance device.

In still another aspect, the present disclosure is directed to a device for servicing a wellbore comprising a portable proppant slurry blender tub; a mechanical conveyance device having a first position for storage during transport and a second position for deployment during operation; wherein the mechanical conveyance device is operable in its second position to mechanically convey and meter dry chemical additive from at or near ground level to the top of the blender tub located at a height above ground level. In an embodiment, the mechanical conveyance device may be pivotally and rotatably mounted to the blender tub so as to be operable to be stowed securely in the first position for transport and deployed for feeding in the second position; and the mechanical conveyance device may further comprise an inlet for feeding of dry additive and a discharge outlet for discharging dry additive directly into the blender tub. The mechanical conveyance device may further comprise a motor operable to drive the conveyor, and the rate of discharge into the blender tub may be approximately in a range from 0.25 cubic feet per minute to four cubic feet per minute.

In still another embodiment, the device may further comprise one or more sand screws for conveying proppant material into the blender tub. The blender tub may mix the dry chemical additive with fracturing fluid and proppant material to form an injection slurry for fracture treating the wellbore. In yet another embodiment, the device may further comprise a pump for injecting slurry into the wellbore. In another embodiment, the device may further comprise a computer operable to control the discharge rate of the mechanical conveyance device into the blender tub to continuously maintain the injection slurry blend. In still another embodiment, the device may further comprise a trailer, wherein the blender tub is mounted to the trailer. The mechanical conveyance device may comprise one from the group consisting of a metering screw, a pneumatic conveyor, a bucket conveyor, and a belt conveyor.

### BRIEF DESCRIPTION OF THE DRAWINGS

For a more complete understanding of the present disclosure, and for further details and advantages thereof, reference is now made to the accompanying drawings, wherein:

FIG. 1A is a perspective drawing of a portable blender tub with a mechanical conveyance device stowed for transport;

FIG. 1B is a side view elevation drawing of a portable blender tub with a mechanical conveyance device stowed for transport;

FIG. 1C is a plan top view drawing of a portable blender tub with a mechanical conveyance device stowed for transport;

FIG. 2A is a perspective view drawing of a portable blender tub with a mechanical conveyance device deployed into feeding position so that dry additive may be conveyed and metered from at or near ground level for discharge into the top of the blender tub;

FIG. 2B is a side view elevation drawing of a portable blender tub with a mechanical conveyance device deployed into feeding position so that dry additive may be conveyed from at or near ground level to be metered for discharge into the top of the blender tub;

FIG. 2C is a plan top view drawing of a portable blender tub with a mechanical conveyance device deployed into feeding position so that dry additive may be conveyed from at or near ground level to be metered for discharge into the top of the blender tub;

FIG. 3A is a perspective drawing of a metering screw mechanical conveyance device with a cut-away showing an auger within a housing;

FIG. 3B is a side elevation view drawing of a metering screw with an incorporated auger revealed via hidden line view;

FIG. 3C is a plan top view drawing of a metering screw housing;

FIG. 3D is a plan top view drawing of an auger; and

FIG. 3E is a side view elevation drawing of a metering screw housing with a hopper attached to the inlet.

### DETAILED DESCRIPTION OF THE INVENTION

Disclosed embodiments concern methods and means for mechanically conveying dry chemical additive in loose form from at or near ground level to some height above ground level (typically associated with the top of a proppant slurry blender tub), so that the dry chemical additive may be mechanically metered into the top of the blender tub. This allows dry chemical additive to be handled completely on the ground during the fracture treatment process of a wellbore, without requiring a handler (typically an oilfield worker whose job involves transporting and removing dry additive from sacks for metering into a blender tub) to climb up to the top of the blender tub with sacks of dry additive. As the fracture treatment process at issue applies to servicing a wellbore in the field, a mechanical conveyance device is generally incorporated with a portable proppant slurry blender tub. Thus, a portable blender tub may be positioned in proximity to a wellbore for on-site fracture treating, with the dry chemical additive being mechanically conveyed up to the top of the blender tub for metered discharge into the blender tub. In the blender tub, the dry chemical additive will be mixed with fracturing fluid and proppant material to form a slurry for injection into the wellbore. Once the wellbore servicing is completed, the portable blender tub may be transported to the next site for treatment.

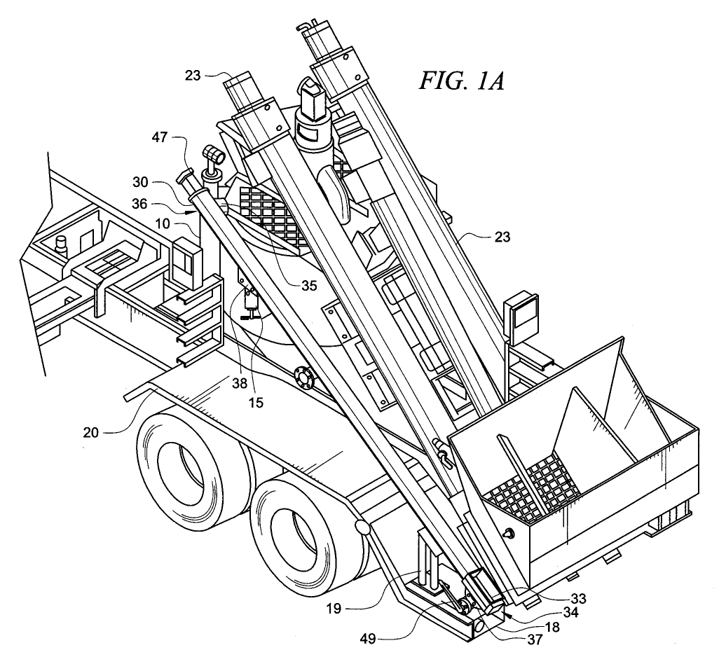

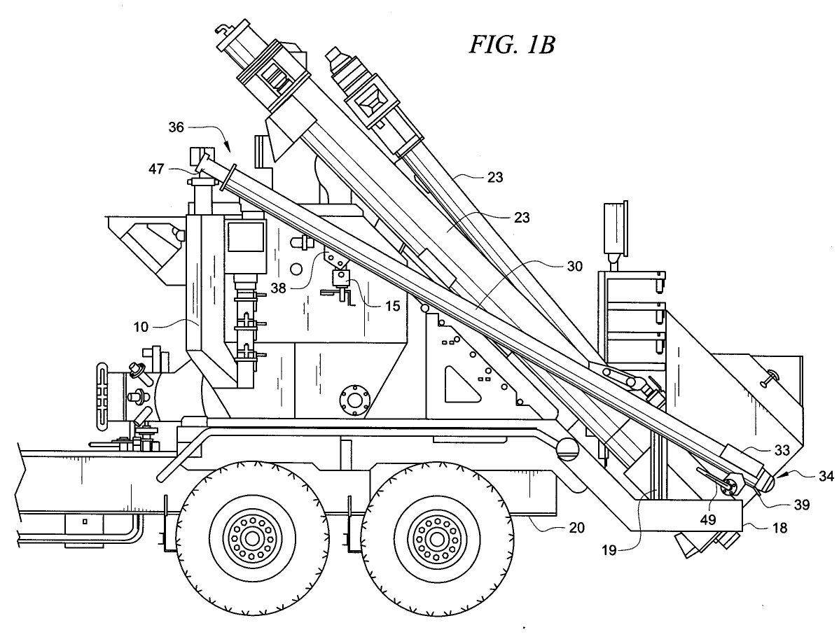

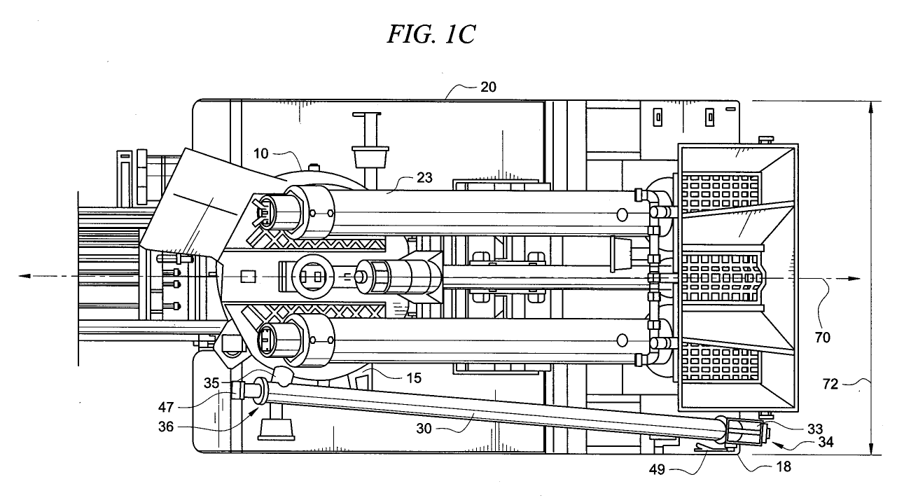

FIGS. 1A, 1B, and 1C illustrate a portable proppant slurry blender tub 10, in particular showing a portable blender tub configured for ready transport. Typically, the blender tub 10 is made portable by being mounted on a vehicular conveyance apparatus, such as a trailer, a skid, a truck or some other motor vehicle, by way of non-exclusive example. In FIG. 1A, the blender tub 10 is mounted on a trailer 20 for portability and ease of transport (allowing a truck to be hitched to the trailer 20 to transport the blender tub 10 from one location to another). Persons skilled in the art field will appreciate and understand that a portable blender tub may utilize an alternative vehicular conveyance apparatus. These alternatives and their equivalents are all included within the scope of this disclosure. In general, a vehicular conveyance apparatus has a longitudinal axis (shown as 70 for trailer 20 of FIG. 1C) extending down its length, and a lateral periphery (shown as 72 for trailer 20 of FIG. 1C) extending the width of the vehicular conveyance apparatus and designating the transverse perimeter of the vehicular conveyance apparatus.

The blender tub 10 mixes dry chemical additive with proppant and fracturing fluid to form an injection slurry for fracture treating a wellbore. The proppant can be any material capable of suspension in the fracturing fluid and operable to retain the fractures within a formation after fracture fluid pressure is removed, allowing formation fluid (such as oil) to flow through the fractured formation. Often sand is used as the proppant. In FIG. 1A, the proppant is conveyed to the blender tub 10 by sand screws 23. Typically, sand screws 23 convey proppant at a rate from about 3 to 150 cubic feet per minute. Fracturing fluid is also pumped into blender tub 10, often with dry chemical additive simultaneously being introduced. As the dry chemical additive, the proppant, and the fracturing fluid enter the blender tub 10, they are mixed together to form an injection slurry. In general, agitators and/or augurs in the blender tub 10 mix the components to form the injection slurry. Once the slurry is prepared, it may be injected into the wellbore. See U.S. Pat. Nos. 4,311,395; 4,854,714; and 4,900,157, incorporated herein by reference, for exemplary details regarding such portable blender tubs.

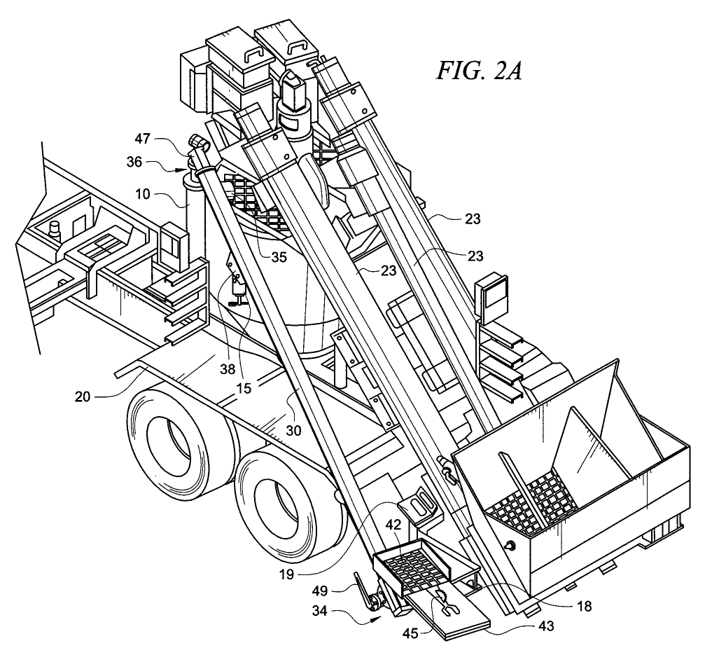

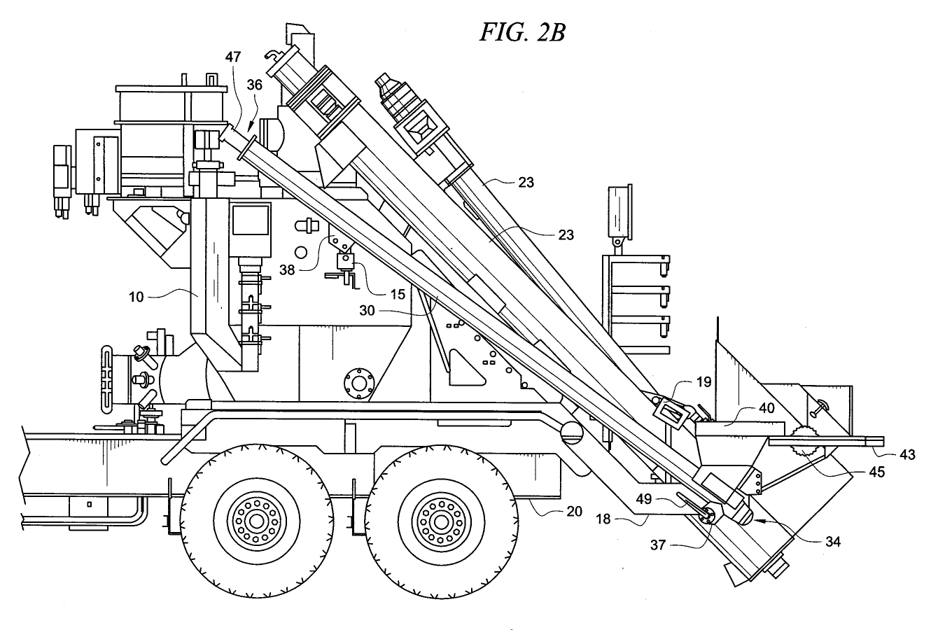

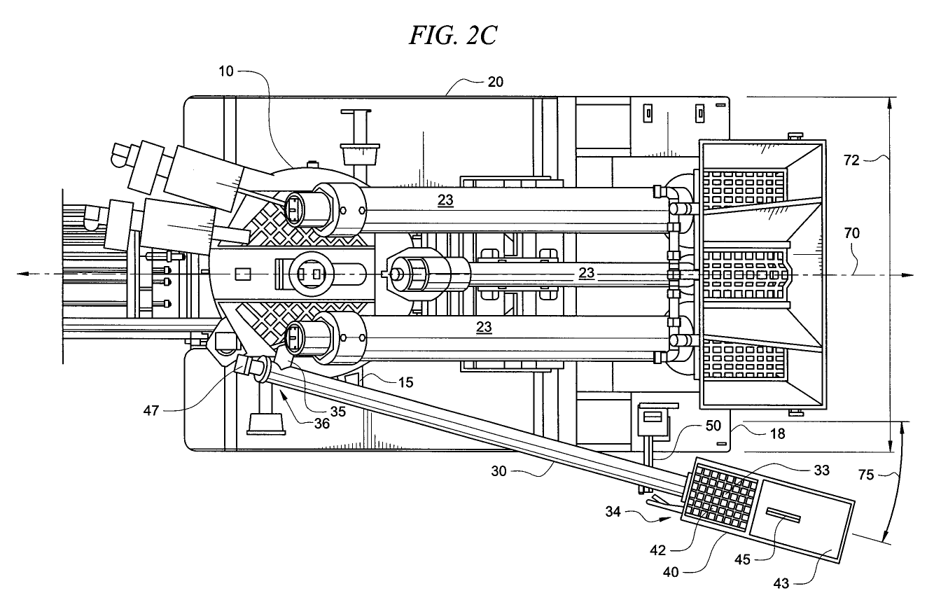

Rather than requiring a handler to carry bags of dry chemical additive up onto the trailer 20 for pouring into a hopper and auger located above the top of the blender tub 10, the embodiment of FIG. 1A allows the handler to remain on the ground while feeding and metering dry chemical additive from bags into the blender tub 10 in loose form using a mechanical conveyance device 30. As used herein, mechanically conveying and metering means that material is transported and metered without further physical handling by an operator, handler, or other person, such that the process is automated. Furthermore, as used herein metering means adding or supplying in a measured or regulated amount, such that the amount of material being added may be controlled. The mechanical conveyance device 30 comprises an inlet end 34 having an inlet 33 for feeding dry additive into the mechanical conveyance device 30 and an outlet end 36 having a discharge outlet 35. The mechanical conveyance device 30 of FIG. 1A is positionable between (at least) two positions. In the first position (shown in FIG. 1A) the mechanical conveyance device 30 is stowed for secure storage during transport, while in the second position (shown in FIG. 2A) the mechanical conveyance device 30 is deployed for operation, allowing the feeding of dry additive for discharge into the blender tub 10. So in its second position, the mechanical conveyance device 30 is operable to mechanically convey dry additive (fed into the inlet 33 in loose form) from at or near ground level to at or above the top of the blender tub 10 for metered discharge out the discharge outlet 35 into the blender tub 10.

The mechanical conveyance device 30 is generally adjustably mounted to the blender tub 10 (allowing repositioning from its first position to its second position). As best shown in FIG. 1B, the mechanical conveyance device 30 is rotatably and pivotally attached to the blender tub 10 at a location between the discharge outlet end 36 and the inlet end 34. In FIG. 1B, the mechanical conveyance device 30 is attached via a flange 38 to a pivoting and rotating support 15 mounted on the side of the blender tub 10, and the point of attachment of the mechanical conveyance device 30 to the blender tub 10 is generally located approximately a quarter to a third of the length of the mechanical conveyance device 30 from the discharge outlet end 36 (such that its is closer to the discharge outlet end 36 than to the inlet end 34).

This pivotal rotating attachment allows for positioning of the mechanical conveyance device from its first, stowed position to its second, deployed position. In FIG. 1A, the inlet end 34 of the mechanical conveyance device 30 may be pivoted vertically, elevating the inlet end 34 upward to lift it free from the stand 19 on the bumper 18 of the trailer 20. The inlet end 34 of the mechanical conveyance device may then be laterally rotated (through arc 75, for example) with respect to the blender tub 10 (and the longitudinal axis 70 of the trailer 20), so that the inlet end 34 extends out beyond the lateral periphery 72 of the trailer 20 (with the inlet 33 located beyond the lateral periphery 72 of the trailer 20). Once the inlet end 34 is laterally positioned with respect to the blender tub 10 and the trailer 20, the inlet end 34 of the mechanical conveyance device 30 may be pivoted back down into its second position. In FIG. 2A, this may be accomplished by lowering the inlet end 34 into position on an extendable support bracket 50 to secure the position of the mechanical conveyance device 30 for feeding. Based on ergonomic considerations (for a handler to effectively deploy the mechanical conveyance device from its first, stowed position to its second, deployed/feeding position), the effort to position the mechanical conveyance device 30 of FIG. 1 would generally be less than 60 lbs, and preferably less than 50 lbs.

In FIG. 1A, the mechanical conveyance device 30 is stowed for transport. In general, the mechanical conveyance device 30 is stowed for transport in its first position, with the inlet 33 located approximately on or above the bumper 18 of the trailer 20, and the discharge outlet 35 not positioned to be operable for discharge into the blender tub 10. As shown in FIG. 1A, the mechanical conveyance device is secured in its stowed position as the inlet end 34 of the mechanical conveyance device 30 is placed and locked onto a stand 19 attached to the bumper 18 of the trailer 20. As shown best in FIG. 1C, this stowed position both secures the mechanical conveyance device 30 for transport and ensures that the inlet end 34 of the mechanical conveyance device 30 does not extend out too far beyond the bumper 18. Thus, the stand 19 secures the mechanical conveyance device 30 for roading (such that transport over public roads may be legally performed).

Once the portable blender tub 10 has been transported into position in proximity to a wellbore to be serviced, the mechanical conveyance device 30 is deployed into feeding position. The mechanical conveyance device 30 is shown in its second, feeding position in FIGS. 2A, 2B, and 2C. As best shown in FIG. 2C, the mechanical conveyance device 30 is deployed for operation by extending a support bracket 50, unlocking the mechanical conveyance device 30 from the stand 19 on the bumper 18, and repositioning the mechanical conveyance device 30 from its stowed position on the stand 19 to its feed position. The mechanical conveyance device 30 is generally deployed from its first, stowed position to its second, feeding position manually, as a handler pivots and rotates the mechanical conveyance device 30 with respect to the blender tub 10 via its connection at the pivoting and rotating support 15. In some embodiments, this manual deployment process may optionally be assisted by either a pneumatic support device or a counterweight attached at or near the discharge end 36 (neither of which is shown in the Figures), operable to reduce the force necessary to move the mechanical conveyance device 30. In FIG. 2A, the force to move the mechanical conveyance device 30 preferably is within a range of approximately 50 to 60 lbs (with the weight of the mechanical conveyance device 30 preferably less than 250 lbs), as this allows for ergonomic positioning by a single handler.

In its feed position, the inlet 33 of the mechanical conveyance device 30 is held at or near ground level by the support bracket 50, while the discharge outlet 35 is positioned at or above the top of the blender tub 10 so that the mechanical conveyance device 30 may discharge directly into the blender tub 10, mechanically metering dry additive from the mechanical conveyance device 30 into the blender tub 10. Generally, in its second, feeding position the mechanical conveyance device 30 extends from at or near the ground level to at or above the top of the blender tub 10 at an angle ranging from about 35 to 45 degrees. The inlet 33 is generally held in proximity to the ground, at a height convenient for a handler on the ground to feed sacks of dry chemical additive into the inlet 33 of the mechanical conveyance device 30. For ergonomic efficiency, the inlet 33 is generally positioned at a height correlating approximately to the zone between a handler's waist and shoulders, with the inlet 33 preferably located at a height from about 30 to 42 inches above the ground. The inlet 33 of FIG. 2C is also located beyond the lateral periphery of the trailer 20. In other words, the inlet end 34 of the mechanical conveyance device 30 extends laterally beyond the width of the trailer 20, providing ample space for the handler to move while feeding dry chemical additive into the inlet 33. In FIG. 2A, the inlet end 34 may be locked in feeding position by attaching to the support bracket 50.

In FIG. 2A, the mechanical conveyance device 30 further comprises a hopper 40, which simplifies feeding of loose dry chemical additive into the mechanical conveyance device 30 as it is poured from sacks into the inlet 33. The hopper 40 is attached to the inlet 33, and serves to funnel dry chemical additive into the inlet 33. Thus, the top portion of the hopper 40 has a larger surface area (facilitating easy feeding of loose dry chemical additive from sacks) that funnels down to feed the inlet 33. In FIG. 2A, the hopper 40 is removably attached to the inlet 33. This allows the hopper 40 to be used while feeding the mechanical conveyance device 30, but removed and stowed when the mechanical conveyance device 30 is prepared for transport (so that that hopper will not project out beyond the bumper 18 in violation of roading regulations). In FIG. 2A, the hopper 40 is sized to hold approximately 2 cubic feet of material.

In FIG. 2A, the hopper 40 further comprises an optional conditioning device, which serves to reduce or minimize clumps of dry chemical additive being fed through the hopper 40 into the inlet 33 so that the loose dry chemical additive material is of consistent bulk density and is ready for effective conveying and metering (as large clumps could interfere with the conveyance mechanism and/or prevent the type of uniform distribution of dry additive necessary for effective metering). In FIG. 2A, the conditioning device is a screen 42 through which the dry additive is poured from sacks into the inlet 33 of the mechanical conveyance device 30. As the dry additive material falls through the screen 42, clumps larger then the grating of the screen will tend to be broken up. Other conditioning devices, such as augers located above the inlet 33, may likewise be used to prevent clumps. Persons of skill in the art will understand such alternatives and their equivalents, all of which are included within the scope of this disclosure.

The hopper 40 of FIG. 2A also comprises an optional height-adjustable work table 43 having an optional, integrated sack cutter 45. The height of the table 43 can be adjusted to approximately match the height of a truck bed loaded with sacks of dry chemical additive. This would allow the sacks to be slid from the truck bed, across the table 43, and into proximity to the hopper 40 for pouring into the inlet 33 of the mechanical conveyance device 30, further reducing the manual labor necessary for conveying and metering dry additive into the blender tub 10. In general, the integral sack cutter 45 is a raised bladed object designed to cut a slit in the bottom of sacks pulled across the table 43. In FIG. 2B, the integral sack cutter 45 is a serrated wheel positioned orthogonal to the table surface 43, rotatably mounted within a slot in the table 43 so that approximately half of its height extends above the table surface 43. As a sack of dry additive is slid across the table 43 towards the hopper 40, it would pass over the sack cutter 45, with its weight pressing down on the blade. The sack cutter 45 would spin, splitting (and thereby cutting open) the bottom of the sack in preparation for the dry additive being poured into the hopper 40.

So when the portable blender tub 10 is positioned in proximity to the wellbore to be serviced and the mechanical conveyance device 30 is deployed into its feeding position, a handler located on or near the ground may slide sacks of dry additive across the table 43 (preferably from the bed of a truck) in preparation for feeding the mechanical conveyance device 30. As each sack slides across the sack cutter, the bottom of the sack is cut open to facilitate pouring of the dry chemical additive from the sack with minimal lifting. The handler then slides the sack over the hopper 40, allowing the dry chemical additive within the sack to pour out into the hopper 40 and down into the inlet 33 to feed the mechanical conveyance device 30.

The mechanical conveyance device 30 then mechanically conveys the loose dry chemical additive material from the inlet 33 at or near ground level to the discharge outlet 35 (located at or above the top of the blender tub 10 when the mechanical conveyance device 30 is in its feeding position as shown in FIG. 2C). The mechanical conveyance device 30 then mechanically meters the dry chemical additive, discharging the appropriate amount into the top of the blender tub 10. By mechanically conveying and metering the loose (non-sacked) dry chemical additive from at or near the ground level to the top of the blender tub 10, the mechanical conveyance device 30 eliminates the need for the handler to climb to the top of the blender tub 10. It further reduces the need for sacks of dry additive to be carried up to the top of the blender tub 10, and for one or more handlers to move and pour sacks of dry chemical additive into the blender tub 10 while operating at some height above ground level. Instead, loose dry chemical additive is conveyed to the top of the blender tub 10 and metered in without further human (manual) physical handling.

Generally, the mechanical conveyance device 30 is driven by a motor, which powers and operates the mechanical conveyance device 30 to convey material from at or near ground level to the top of the blender tub 10 for automated metering into the tub 10. In FIG. 2A, a hydraulic motor 47 operates the mechanical conveyance device 30 in a forward direction to convey material from at or near ground level to the top of the blender tub 10. Generally, the rate of discharge of the mechanical conveyance device 30 (based on the hydraulic motor 47) is approximately in a range from 0.25 cubic feet per minute to four cubic feet per minute for dry chemical additive material (typically fine powders) with densities approximately in a range from 30 lbm per cubic foot to 70 lbm per cubic foot. The mechanical conveyance device 30 of FIG. 2A also generally has a volumetric accuracy of 3% or better, in order to allow for sufficient control over metering of the dry chemical additive to accurately produce the injection slurry. Generally, a computer controls the motor 47 so that the mechanical conveyance device 30 will mechanically convey and meter an appropriate amount of dry chemical additive into the blender tub 10 on a continuous basis. In this way, the rate of discharge of dry chemical additive into the blender tub 10 may be controlled to continuously maintain the appropriate injection slurry blend composition (with the ratio of dry chemical additive relative to fracturing fluid and proppant being maintained). Controlling the rate of discharge may be important for achieving an appropriate injection slurry, as fracturing fluid, proppant, and dry chemical additive are generally continuously and/or simultaneously added to the blender tub 10 and mixed into an injection slurry, even while the injection slurry in the blender tub 10 may be pumped downhole for injection into the wellbore. The computer controlled discharge rate may vary based on factors such as material flow ability, particle size, moisture content, and bulk density.

In FIG. 2A, the dry chemical additive is non-proppant material. Proppant (generally sand) is added into the blender tub 10 via sand screw(s) 23, while the dry chemical additive is metered into the blender tub simultaneously via mechanical conveyance device 30. By separately adding dry chemical additive and proppant to the fracturing fluid within the blender tub 10 at the same time, more precise control over the continuous composition of the injection slurry may be maintained (ensuring that the slurry has the appropriate composition). In FIG. 2A, the mechanical conveyance device 30 adds dry chemical additive to the blender tub 10 at a first, precision metering rate, while the sand screw(s) 23 add proppant to the blender tub 10 at a second, bulk metering rate.

In FIG. 2A, the operational range of the mechanical conveyance device 30 typically allows for metering of about 0.25 to four cubic feet of dry chemical additive per minute, while the operational range of the sand screw(s) 23 typically allow for bulk metering of proppant at a rate of about 3 to 150 cubic feet per minute. In actual use during mixing of the injection slurry, the mechanical conveyance device 30 typically meters approximately between 10 to 50 pounds (lbs) of dry chemical additive per mgal (1000 gallons) of fracturing fluid, while the sand screw(s) typically meter approximately between 0.5 to 20 pounds (lbs) of proppant per gallon of fracturing fluid. Additionally, the mechanical conveyance device 30 offers tighter metering tolerances for more precise control over the amount of dry chemical additive metered into the fracturing fluid. Typically, the mechanical conveyance device 30 provides volumetric accuracy of 3% or better, which can be important when metering dry chemical additive since subtle changes may significantly impact the characteristics and performance of the injection slurry. Proppant, on the other hand, is generally bulk metered into the fracturing fluid within the blender tub 10 without such precise tolerances.

The blender tub 10 mixes the dry chemical additive, the proppant, and the fracturing fluid together to form an injection slurry for fracture treating the wellbore. Generally, the blender tub 10 uses one or more agitators and/or augers to blend the injection slurry. The injection slurry is then pumped from the blender tub 10 down into the wellbore to fracture treat the well site. Mixing and pumping generally occur simultaneously, so the injection slurry blend should be continuously maintained (requiring controlled metering of dry chemical additive into the blender tub 10).

Upon completion of the wellbore fracture treatment process, the hopper 40 of FIG. 2A is removed and the mechanical conveyance device 30 is stowed back in its first position (locked in place in the stand 19 on the bumper 18). Stowing may specifically require that the mechanical conveyance device 30 be unlocked from the support bracket 50 and repositioned onto the stand 19. The support bracket 50 may then be retracted, and the mechanical conveyance device 30 may be locked in the stand 19 for secure transport. The mechanical conveyance device 30 may also, optionally, be cleaned and/or discharged (generally prior to being stowed for transport). In FIG. 2B, the mechanical conveyance device 30 further comprises a cleanout valve 37 located beneath the inlet 33. The cleanout valve 37 may be opened via handle 49, and when opened, provides a means of exit out the inlet (bottom) end of the mechanical conveyance device 30. Thus, the motor 47 of FIG. 2A may be run in reverse with the cleanout valve 37 opened, ejecting/discharging any remaining dry chemical additive material charging the length of the mechanical conveyance device 30 out through the cleanout valve 37. By discharging the mechanical conveyance device 30, remaining dry chemical additive may be recovered. In addition, the mechanical conveyance device 30 may be prepared for use with another, different dry chemical additive.

The mechanical conveyance device 30 shown in FIGS. 1A, 1B, 1C, 2A, 2B, and 2C and discussed above may be any type of device capable of mechanically conveying and metering dry additive from at or near ground level to some height above ground level (typically at or above the top of the blender tub 10). Generally the mechanical conveyance device 30 conveys material vertically (from at or near ground level to some height above ground level in proximity to the top of the blender tub 10), but it often also translates material horizontally so that the inlet 33 for feeding the material can be conveniently located. In FIG. 2A, the mechanical conveyance device 30 transports material vertically from a height of approximately 30 inches to a height of approximately 102 inches, while also translating the material horizontally approximately 103 inches (allowing ample space away from the frailer 20 for the handler to operate).

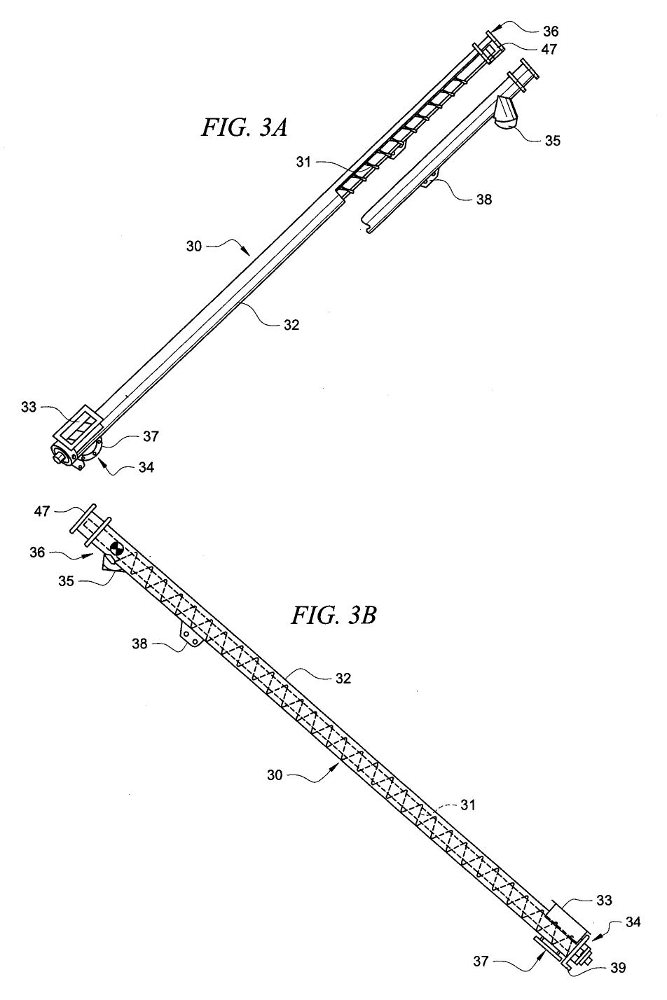

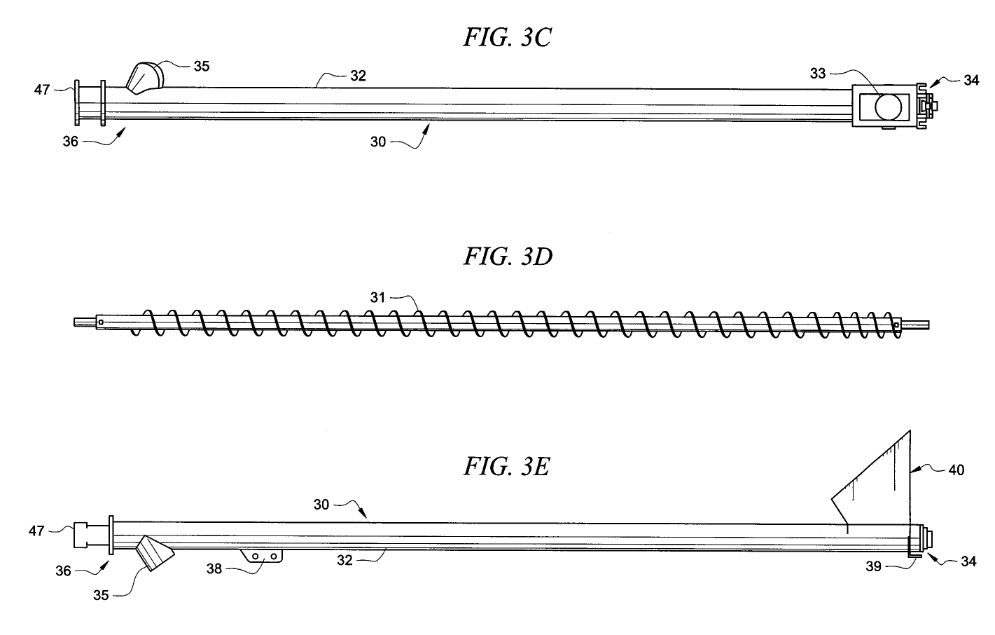

A wide variety of mechanical conveyance devices 30 are feasible for use with a portable blender tub 10. By way of non-exclusive example, the mechanical conveyance device 30 could be a pneumatic conveyor, a bucket conveyor, a belt conveyor, or a metering screw conveyor. FIGS. 1A and 2A specifically illustrate a metering screw used to convey and meter the dry chemical additive material from at or near ground level to the top of the blender tub 10. The metering screw of FIGS. 1A and 2A may be seen in more detail in FIGS. 3A, 3B, 3C, 3D, and 3E.

As FIG. 3A illustrates, the metering screw mechanical conveyance device 30 comprises an auger 31 within a housing 32. In FIG. 3A, the auger 31 is carbon steel for durability, while the housing 32 is aluminum for reduced weight (to improve ease of manual positioning of the metering screw 30 during deploying and stowing). Persons skilled in the art will understand and appreciate that an array of materials may be available for constructing the auger 31 and its housing 32, all of which are included along with their equivalents within the scope of this disclosure. As the auger 31 turns in a forward direction, it conveys material (such as loose dry chemical additive) up through the housing 32. The housing 32 comprises an inlet 33 and a discharge outlet 35, along with a flange 38 for attachment to the rotatable, pivotable support 15 mounted to the portable blender tub 10. In FIG. 3B, the housing 32 further comprises a cleanout valve 37 and a tab 39 that may be used to lock the metering screw 30 in place with respect to the extendable support bracket 50 (when the metering screw 30 is deployed in position for feeding).

A hydraulic motor 47, attached to the discharge end 36 of the metering screw 30 in FIG. 3A, operates the auger 31. As the auger 31 turns in a forward direction, the metering screw conveys dry chemical additive material from the inlet 33 to the discharge outlet 35. On the other hand, if the cleanout valve 37 is opened and the motor 47 is run in reverse, then the auger will convey material from the discharge outlet 35 towards the inlet, and the metering screw 30 will eject/discharge any remaining dry chemical additive material charging the length of the metering screw 30 out the cleanout valve 37. Generally, the hydraulic motor 47 of FIG. 2A is run off an overall hydraulic power pack for the entire trailer 20. And while the inlet 33 may comprise an integrated hopper 40, in FIG. 3E, a removable hopper 40 is affixed to the inlet to ease feeding of the metering screw 30.

In operation, the portable blender tub 10 is generally first transported to the well site for fracture treating a wellbore. The mechanical conveyance device 30 is deployed from its first, storage position (where it is stowed for transport as shown in FIG. 1A) to its second position for feeding (as shown in FIG. 2A). In FIGS. 1A and 2A, the mechanical conveyance device is pivotally and rotatably repositioned from its first, stowed position to its second, deployed position (ready for feeding). In FIG. 1A, the mechanical conveyance device 30 is securely stowed for transport in a stand 19 on the bumper 18. Thus, the mechanical conveyance device 30 would be unlocked from its secured position in the stand 19. The fixation support bracket 50 would be extended out into position for supporting the mechanical conveyance device 30 in its second position. The mechanical conveyance device 30 would be deployed by being repositioned from its first stowed position to its second position for feeding.

More specifically, in FIG. 1A, the inlet end 34 of the mechanical conveyance device 30 would be vertically pivoted upward with respect to the blender tub (pivoting about its attachment point, flange 38, mounted on the blender tub at 15). This would elevate the inlet end 34, freeing it from the stand 19. The inlet end 34 of the mechanical conveyance device 30 could then be laterally rotated through an arc 75 with respect to the longitudinal axis 70 of the trailer 20 (with the mechanical conveyance device 30 rotating about the pivotal rotatable mounting point 15 on the blender tub 10). In other words, the inlet end 34 of the mechanical conveyance device 30 would be translated laterally beyond the width (lateral periphery 72) of the trailer 20. Then, the inlet end 34 of the mechanical conveyance device 30 could be pivoted downward into its second, feeding position, lowering to rest atop support bracket 50. The mechanical conveyance device 30 would then generally be secured to the fixation support bracket 50, locking the mechanical conveyance device 30 into its second position (as shown in FIG. 2A) in preparation for feeding.

In the second position, the discharge outlet 35 of the mechanical conveyance device 30 is positioned at or above the top of the blender tub 10 so that it discharges directly into the blender tub 10; the inlet 33 of the mechanical conveyance device 30 is positioned in proximity to the ground, so that a handler located on the ground may conveniently feed the mechanical conveyance device 30. Furthermore, the inlet 33 of FIG. 2A is positioned beyond the lateral periphery 72 of the trailer 20, providing ample space for a handler to move while feeding the mechanical conveyance device 30. In FIG. 1A, the mechanical conveyance device 30 does not have a hopper integrated with the inlet 33 of the mechanical conveyance device 30. Thus, a removable hopper 40 may be affixed to the inlet 33 to facilitate feeding of the mechanical conveyance device 30. Furthermore, as shown in FIG. 2A, the hopper 40 may have an optional integrated height-adjustable table 43 with an optional integral sack cutter 45. The table 43 may provide a convenient path for sliding sacks of dry chemical additive from a conveyance (such as the bed of a truck) to the hopper 40. If so, then the height-adjustable table 43 may be positioned so that its distal end approximately matches the height of a truck bed or other means of conveying sacks of dry chemical additive (which has been positioned in proximity to the hopper 40). Then sacks of dry chemical additive may be slid from the conveyance means to the hopper 40, reducing the amount of labor required to unload the truck and feed the mechanical conveyance device 30.

The sacks would be cut open, so that the contents may be fed into the inlet 33 of the mechanical conveyance device 30. If the adjustable table 43 further includes an integral sack cutter 45, then as the bags of dry chemical additive are slid across the table 43, the bottom of the sacks would automatically be cut open. This would allow for efficient feeding of the mechanical conveyance device 30, as the opened sacks could simply be slid over the hopper 40, pouring their contents into the hopper 40 for feeding of the mechanical conveyance device 30 via the inlet 33.

Dry chemical additive is fed into the inlet 33 of the mechanical conveyance device 30 in loose form, generally by pouring the dry chemical additive from sacks into the inlet 33. By emptying the sacks into the inlet 33 of the mechanical conveyance device 30, the mechanical conveyance device 30 may then mechanically convey the dry chemical additive in loose form from at or near ground level to the top of the blender tub 10 for metered discharge into the blender tub 10. It may also prove useful to optionally condition the dry chemical additive as it is poured from sacks, in order to ensure that the loose dry chemical additive is fairly uniform and evenly distributed in the mechanical conveyance device 30 for effective mechanical metering into the blender tub 10.

Specifically, it may be useful to ensure that the dry chemical additive does not contain clumps that might adversely affect the metering of the additive into the blender tub 10. A conditioning device may be incorporated into the hopper 40, by way of example, to assist in providing the dry chemical additive in a uniform loose form. By way of non-exclusive example, the hopper 40 may have a screen 42 or grate atop it to break up clumps. Alternatively, the conditioning device could be a screw or auger towards the bottom of the hopper 40 designed to break clumps and mix the dry chemical additive. Persons skilled in the art field will appreciate and understand alternative conditioning devices and their equivalents, all of which are intended to be included within the scope of this disclosure.

As the mechanical conveyance device 30 is being fed, it mechanically conveys the dry chemical additive in loose form from at or near ground level to the top of the blender tub 10 for mechanically metered discharge into the blender tub 10. For the mechanical conveyance device 30 of FIG. 3A, which is a metering screw, the length of the metering screw 30 would first need to be charged with dry chemical additive in order to be prepared for metered discharge into the blender tub 10. In other words, the mechanical conveyance device 30 would generally be run sufficiently to transport dry chemical additive from the inlet 33 just to the discharge outlet 35, filling the entire length of the metering screw 30 with dry chemical additive so that the specific amount of dry chemical additive to be metered into the blender tub 10 could be controlled.

The mechanical conveyance device 30 may be motor driven, in which case the handler or some other operator would operate the motor 47 to convey and meter the dry chemical additive into the blender tub 10. Control of the motor 47 may also be computerized, with the computer determining the speed of the motor 47 in order to accurately meter the dry chemical additive into the blender tub 10 (in which case, the operator would operate and/or program the computer to control mechanical conveyance and discharge). Regardless, the rate of discharge of dry chemical additive into the blender tub 10 may be controlled based on the speed of the motor 47 running the mechanical conveyance device 30. In the case of the metering screw mechanical conveyance device 30 of FIG. 3A, the rate of discharge may relate to the dimensions of the screw, the rate at which it turns, and the material properties of the dry chemical additive. Generally, the mechanical conveyance device 30 would be capable of metering dry chemical additive with a density ranging from about 30 to 70 lbm per cubic foot at rates of about 0.25 to 4.0 cubic feet per minute, with a volumetric accuracy of about 3% or better.

In addition to metering dry chemical additive into the blender tub 10, fracturing fluid and proppant are added into the blender tub 10, with the dry chemical additive blended with the fracturing fluid and the proppant to form an injection slurry. In FIG. 2A, the proppant is added to the blender tub 10 using sand screw(s) 23. Generally, the rate of discharge of dry chemical additive into the blender tub 10 is computer controlled to continuously maintain the appropriate slurry blend mixture composition for fracture treating a wellbore. The dry chemical additive generally will be added into the blender tub simultaneously with proppant (typically added via sand screws) and fracturing fluid. If so, then an operator can program the necessary information into the computer to ensure the appropriate slurry mixture. In general, dry chemical additive and proppant may be metered simultaneously into the blender tub 10 at two different rates, with the dry chemical additive metered at a first rate lower than the second, bulk rate at which the proppant is metered. By way of example, in operation the mechanical conveyance device 30 typically meters approximately between 10 and 50 pounds (lbs) of dry chemical additive per mgal (1000 gallons) of fracturing fluid, while the sand screw(s) typically meter approximately between 0.5 and 20 pounds (lbs) of proppant per gallon of fracturing fluid. Additionally, the mechanical conveyance device 30 meters dry chemical additive with much greater precision than the sandscrew(s) are typically capable of, since the effectiveness of the injection slurry may be more strongly influenced by small changes to the amount of dry chemical additive. Thus, the mechanical conveyance device 30 typically has a volumetric accuracy of 3% or better (while the sand screw(s) generally have a lower accuracy level).

Once the injection slurry is formed, the wellbore may be fracture treated. The injection slurry is pumped into the wellbore in order to service the well. Generally, the injection slurry is continuously blended and injected into the well (although the slurry could be batch mixed for injection as well). In other words, the proppant, dry chemical additive, and fracturing fluid are continuously added to the blender tub 10 to form an injection slurry, even as the injection slurry is injected into the wellbore, with the amount of the dry chemical additive and the proppant added to the fracturing fluid in the blender tub 10 typically being controlled to continuously maintain the injection slurry blend. After fracture treatment is completed, the mechanical conveyance device 30 may be cleaned and/or discharged in preparation for transport. Generally, cleaning/discharging of the mechanical conveyance device 30 shown in FIG. 3A is accomplished by opening the cleanout valve 37 and reversing the motor 47 (so that the mechanical conveyance device 30 runs backwards to eject any remaining dry chemical additive material charging the mechanical conveyance device 30 out through the cleanout valve 37).

Then, the mechanical conveyance device 30 would be stowed in preparation for transport of the portable blender tub 10 from the site. In FIG. 2A, the mechanical conveyance device 30 would be unlocked/unsecured from its second position affixed to the fixation support bracket 50. The fixation support bracket 50 would then be retracted, and the mechanical conveyance device 30 would be stowed in the stand 19 on the bumper 18 (generally by being manually pivoted and rotated into place). The mechanical conveyance device 30 would then be secured in the stand 19, generally locked in place in its first position in preparation for secure transport. Once the mechanical conveyance device 30 has been stowed, the portable blender tub 10 would be transported from the well site, so that it could be used at another well site.

In this way, an injection slurry for fracture treating and stimulating a wellbore may be mixed on-site, combining fracturing fluid, proppant, and metered dry chemical additive continuously without the need for a handler to climb and carry sacks of additive up to the top of the portable blender tub 10. This allows for effective and efficient service of a wellbore, while minimizing safety hazards and reducing the required manpower for feeding dry chemical additive into the blender tub 10. And while primarily described for use in metering dry additive onsite to mix injection slurry during wellbore servicing, the mechanical conveyance device may also have other uses. By way of non-exclusive example, the device could alternatively be used to batch mix (non-portable) tanks of injection slurry for use at a later date at various well sites (with the pre-mixed injection slurry then being transported for use at individual well sites).

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Accordingly, the scope of protection is not limited by the description set out above, but is defined by the claims which follow, that scope including all equivalents of the subject matter of the claims. Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings refer to a “Field of the Invention,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

What is claimed is:

1. A method for servicing a wellbore comprising:
transporting a portable proppant slurry blender tub to a well site to be serviced;
deploying a mechanical conveyance device from a first position for storage during transport to a second position for feeding dry chemical additive for metered discharge into the blender tub; and
mechanically conveying and metering dry chemical additive from at or near ground level to the top of the blender tub.

2. A method as in claim 1 further comprising:
feeding the dry chemical additive into the mechanical conveyance device;
wherein the dry chemical additive is fed into the mechanical conveyance device from sacks so that it may be mechanically conveyed in loose form from at or near ground level to the top of the blender tub.

3. A method as in claim 2 wherein the dry chemical additive is a non-proppant material.

4. A method as in claim 2 wherein:
the mechanical conveyance device further comprises an inlet and a discharge outlet; and
in the second position the mechanical conveyance device has its inlet located at or near the ground and its discharge outlet located at or above the top of the blender tub so that the mechanical conveyance device discharges directly into the blender tub.

5. A method as in claim 4 wherein the mechanical conveyance device is deployed by pivoting and/or rotating the inlet of the mechanical conveyance device with respect to the blender tub.

6. A method as in claim 4 wherein:
the blender tub is located on a vehicular conveyance apparatus having a longitudinal axis defining the length of the vehicular conveyance apparatus and a lateral periphery defining the width of the vehicular conveyance apparatus; and
in the second position, the inlet of the mechanical conveyance device extends beyond the periphery of the vehicular conveyance apparatus.

7. A method as in claim 6 wherein deploying the mechanical conveyance device further comprises:
pivoting the inlet of the mechanical conveyance device vertically upward with respect to the blender tub;
rotating the inlet of the mechanical conveyance device through a lateral arc with respect to the bender tub and the longitudinal axis of the vehicular conveyance apparatus;
pivoting the inlet of the mechanical conveyance device downward with respect to the blender tub into the second position; or
combinations thereof.

8. A method as in claim 4 further comprising:
adding fracturing fluid and proppant into the blender tub;
blending the dry chemical additive with the fracturing fluid and the proppant within the blender tub to form an injection slurry; and
fracture treating the wellbore with the injection slurry.

9. A method as in claim 8 wherein:
the proppant and the dry chemical additive are added to the blender tub simultaneously via separate conveyance devices; and
the amount of the dry chemical additive and the proppant added into the blender tub is continuously controlled to maintain the injection slurry blend.

10. A method as in claim 4 further comprising cutting open a sack of dry chemical additive, wherein the dry chemical additive is fed into the mechanical conveyance device by being poured from the open sack into the inlet.

11. A method as in claim 4 further comprising:
charging the mechanical conveyance device with dry chemical additive;
discharging the mechanical conveyance device to remove dry chemical additive charged to the mechanical conveyance device;
stowing the mechanical conveyance device from the second position to the first position in preparation for transportation; and
transporting the portable blender tub from the well site upon completion of wellbore servicing.

12. A method for servicing a wellbore comprising:
transporting a portable proppant slurry blender tub to a well site to be serviced;
mechanically conveying dry chemical additive from at or near ground level to the top of the blender tub;
adding fracturing fluid to the blender tub;
metering the dry chemical additive into the blender tub; and
metering proppant into the blender tub;
wherein the proppant and dry chemical additive are simultaneously metered into the fracturing fluid within the blender tub.

13. A method as in claim 12 wherein:
the proppant, dry chemical additive, and fracturing fluid are continuously added to the blender tub to form an injection slurry, even as the injection slurry is injected into the wellbore; and
the amount of the dry chemical additive and the proppant added to the fracturing fluid in the blender tub is controlled to continuously maintain the injection slurry blend.

14. A method as in claim 12 wherein metering of the dry chemical additive occurs at a rate approximately in a range from 0.25 cubic feet per minute to 4 cubic feet per minute; with a volumetric accuracy of approximately 3% or better.

15. A device for servicing a wellbore comprising:
a mechanical conveyance device adjustably mounted to a portable proppant slurry blender tub;
wherein the mechanical conveyance device has a first position for storage during transport and a second position for feeding dry chemical additive for discharge into the blender tub; and
wherein in its second position, the mechanical conveyance device is operable to mechanically convey dry chemical additive from at or near ground level to the top of the blender tub for metered discharge into the blender tub.

16. A device as in claim 15 wherein:
the mechanical conveyance device is pivotally and/or rotatably mounted to the blender tub and configured to be stowed securely in the first position for transport and deployed for feeding in the second position.

17. A device as in claim 16 wherein:
the mechanical conveyance device further comprises an inlet and a discharge outlet; and
in the second position the mechanical conveyance device has its inlet located at or near the ground and its discharge outlet located at or above the top of the blender tub so that the mechanical conveyance device discharges directly into the blender tub.

18. A device as in claim 17 wherein:
the blender tub is located on a vehicular conveyance apparatus having a lateral periphery defining the width of the vehicular conveyance apparatus; and
in the second position, the inlet of the mechanical conveyance device extends beyond the lateral periphery of the vehicular conveyance apparatus.

19. A device as in claim 17 further comprising one or more sand screws for conveying proppant material into the blender tub.

20. A device as in claim 17 wherein the mechanical conveyance device further comprises a cleanout valve and a motor operable to drive the mechanical conveyance device in a forward direction for conveying dry chemical additive to the blender tub and a reverse direction to discharge dry chemical additive charged to the mechanical conveyance device through the cleanout valve.

21. A device as in claim 19 wherein the mechanical conveyance device has a volumetric accuracy of 3% or better.
